(19) United States
(12) Patent Application Publication
(10) Pub. No.: US 2020/0210459 A1
(43) Pub. Date: Jul. 2, 2020

(54) METHOD AND APPARATUS FOR CLASSIFYING SAMPLES

(71) Applicant: Alibaba Group Holding Limited, George Town (KY)

(72) Inventors: Shuheng Zhou, Hangzhou (CN); Huijia Zhu, Hangzhou (CN); Zhiyuan Zhao, Hanzghou (CN)

(73) Assignee: Alibaba Group Holding Limited, George Town (KY)

(21) Appl. No.: 16/812,121

(22) Filed: Mar. 6, 2020

Related U.S. Application Data
(63) Continuation of application No. PCT/CN2018/100758, filed on Aug. 16, 2018.

(30) Foreign Application Priority Data
Dec. 12, 2017 (CN) 201711322274.2

(51) Int. Cl. G06F 16/28; G06K 9/62

(52) U.S. Cl. CPC G06F 16/285; G06K 9/627; G06K 9/6215

(57) ABSTRACT

A candidate sample (T) and respective features (Ft) of the candidate sample (T) are obtained. A predetermined positive integer (N) samples are selected from a classification sample library. A feature similarity (SIMi) is determined between the candidate sample (T) and each of the N samples (i), where the feature similarity (SIMi) is determined based on the respective features (Ft) of the candidate sample (T) and respective features (Fi) of each sample (i). A sample quality (Qi) of each sample (i) is obtained. As comprehensive similarity measures (Si), a comprehensive similarity measure (Si) is determined between the candidate sample (T) and each sample (i) at least based on a difference (ri) between the feature similarity (SIMi) and the sample quality (Qi). Based on the comprehensive similarity measures (Si), a determination is performed as to whether the candidate sample (T) belongs to a classification within the classification sample library.

### CROSS-REFERENCE TO RELATED APPLICATIONS

This application is a continuation of PCT Application No. PCT/CN2018/100758, filed on Aug. 16, 2018, which claims priority to Chinese Patent Application No. 201711322274.2, filed on Dec. 12, 2017, and each application is hereby incorporated by reference in its entirety.

### TECHNICAL FIELD

One or more implementations of the present specification relate to the field of computer technologies, and in particular, to sample classification and identification.

### BACKGROUND

As the Internet is upgraded, a wide variety of information and content are generated on the network every day. In many cases, these information and content need to be identified and classified. For example, many network platforms generate a large amount of junk information, advertising information, etc. To ensure user experience, junk information and advertising information need to be identified and filtered. For another example, to improve the network environment, it is also necessary to identify and classify content of the network that contains pornography, violence or that violates laws and regulations.

To identify and classify the network content, the method of establishing a classification sample library is usually used. For example, an advertisement “black sample” library can be created for advertising information, where collected exemplary samples, also referred to as black samples, are stored. The network content to be evaluated is compared with the black sample in the black sample library to determine whether the network content to be evaluated falls in the same category, that is, whether it is also an advertisement.

Typically, the sample library contains a large quantity of exemplary samples. These samples are usually collected manually and therefore vary in quality. Some exemplary samples are of low quality, and have a poor generalization ability. Therefore, the content to be evaluated does not fall into the same category as the sample even though the content has a high similarity with the latter. This brings much difficulty in classifying and evaluating samples.

Therefore, a solution for improvement is needed to evaluate and classify the content to be evaluated and samples more effectively.

### SUMMARY

One or more implementations of this specification describe a method and an apparatus. Similarity between a sample to be evaluated and an exemplary sample is evaluated more effectively and more accurately by introducing sample quality of the exemplary sample during evaluation.

According to a first aspect, a method for classifying a sample to be evaluated is provided, including: obtaining sample T to be evaluated and sample feature Ft of sample T to be evaluated; selecting the first quantity N of exemplary samples from a classification sample library; obtaining feature similarity SIMi between sample T to be evaluated and each of the N exemplary samples i, where feature similarity SIMi is determined based on sample feature Ft of sample T to be evaluated and sample feature Fi of each exemplary sample i; obtaining sample quality Qi of each exemplary sample i; determining comprehensive similarities Sis between sample T to be evaluated and each exemplary sample i based on at least difference ri between feature similarity SIMi and sample quality Qi; and determining, based on comprehensive similarity Si, whether sample T to be evaluated falls in the category of the classification sample library.

In one implementation, the selecting the first quantity N of exemplary samples from a classification sample library includes: calculating feature similarities between sample T to be evaluated and each of the second quantity M of exemplary samples based on sample feature Ft of sample T to be evaluated and sample features of the second quantity M of exemplary samples in the classification sample library, where the second quantity M is greater than the first quantity N; and selecting the first quantity N of exemplary samples from the second quantity M of exemplary samples based on feature similarity between the sample to be evaluated and each of the second quantity M of exemplary samples.

In one implementation, the selecting the first quantity N of exemplary samples from a classification sample library includes selecting the first quantity N of exemplary samples from the classification sample library based on sorting of sample quality of each sample in the classification sample library.

According to one implementation, feature similarity SIMi is determined by normalizing the distance between sample feature Ft of sample T to be evaluated and sample feature Fi of each exemplary sample i.

In one implementation, determining comprehensive similarity Si between sample T to be evaluated and each exemplary sample i includes determining comprehensive similarity Si as Si=a+b*ri*c, where a+b=1, and c is a coefficient associated with sample quality Qi.

In one implementation, in the case of ri>=0, c=1/(1−Qi) and in the case of ri<0, c=1/Qi.

According to one implementation, the method further includes determining a total similarity score of the sample to be evaluated based on comprehensive similarity Si between the sample to be evaluated and each exemplary sample i.

In one implementation, the determining a total similarity score of the sample to be evaluated includes: if at least one ri>=0, determining the total similarity score as the maximum value among comprehensive similarities Sis between sample T to be evaluated and each exemplary sample i; or otherwise, determining the total similarity score as the minimum value among comprehensive similarities Sis between sample T to be evaluated and each exemplary sample i.

In one implementation, the determining a total similarity score of sample to be evaluated includes determining the total similarity score as the average value of comprehensive similarities Sis between sample T to be evaluated and each exemplary sample i.

According to a second aspect, an apparatus for classifying samples to be evaluated is provided, including: a sample acquisition unit, configured to obtain sample T to be evaluated and sample feature Ft of sample T to be evaluated; a selection unit, configured to select the first quantity N of exemplary samples from a classification sample library; a first acquisition unit, configured to obtain feature similarity SIMi between sample T to be evaluated and each exemplary sample i of the N exemplary samples, where feature similarity SIMi is determined based on sample feature Ft of sample T to be evaluated and sample feature Fi of each exemplary sample i; a second acquisition unit, configured to obtain sample quality Qi of each exemplary sample i; a processing unit, configured to determine a comprehensive similarity Si between sample T to be evaluated and each exemplary sample i based on at least difference ri between feature similarity SIMi and sample quality Qi; and a classification unit, configured to determine, based on comprehensive similarity Si, whether sample T to be evaluated falls in the category of the classification sample library.

According to a third aspect, a computer readable storage medium is provided, where the medium stores a computer program, and when the computer program is executed in a computer, the computer is enabled to perform the method of the first aspect.

According to a fourth aspect, a computing device is provided, including a memory and a processor, where the memory stores executable code, and when the processor executes the executable code, the method of the first aspect is implemented.

When the method and the apparatus provided in the implementations of this specification are used, the feature similarity between the sample to be evaluated and the exemplary sample and the sample quality of the exemplary sample are considered in determining the comprehensive similarity between the sample to be evaluated and the exemplary sample. Based on the comprehensive similarity, the sample to be evaluated is classified, thereby reducing or avoiding the adverse impact of the varied sample quality on the evaluation results and making it more effective and more accurate to determine the category of the sample to be evaluated.

### BRIEF DESCRIPTION OF DRAWINGS

To describe the technical solutions in the implementations of the present invention more clearly, the following briefly introduces the accompanying drawings required for describing the implementations. Apparently, the accompanying drawings in the following description are merely some implementations of the present invention, and a person of ordinary skill in the field may still derive other drawings from these accompanying drawings without creative efforts.

FIG. 1 is a schematic diagram illustrating an application scenario of an implementation disclosed in this specification;

FIG. 2 is a flowchart illustrating a method, according to one implementation;

FIG. 3 is a flowchart illustrating selection of a certain quantity of exemplary samples, according to one implementation;

FIG. 4 is a flowchart illustrating selection of a certain quantity of exemplary samples, according to another implementation;

FIG. 5 is a flowchart illustrating selection of a quantity of exemplary samples, according to still another implementation; and

FIG. 6 is a schematic block diagram illustrating a classification apparatus, according to one implementation.

### DESCRIPTION OF IMPLEMENTATIONS

The solution provided in this specification is described below with reference to the accompanying drawings.

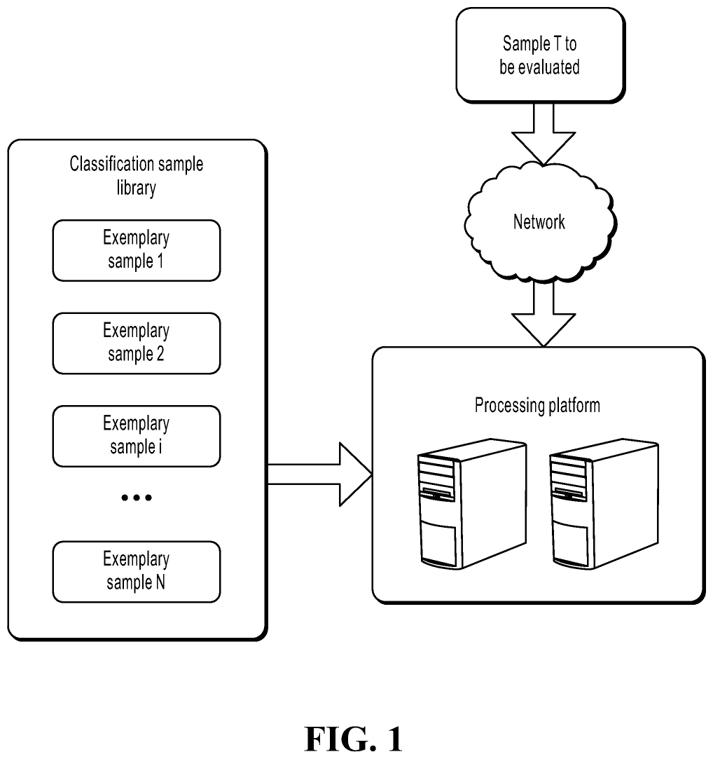

FIG. 1 is a schematic diagram illustrating an application scenario of an implementation disclosed in this specification. In FIG. 1, a processing platform obtains a sample to be evaluated and sample information of exemplary samples from a sample library. The sample information includes sample features of exemplary samples and sample quality of exemplary samples. The processing platform then determines comprehensive similarity between the sample to be evaluated and the exemplary samples based on feature similarity between the sample to be evaluated and each of the exemplary samples and sample quality of the exemplary samples. The described processing platform can be any platform with computing and processing capabilities, such as a server. The described sample library can be created by collecting samples and is used to classify or identify samples, including a plurality of exemplary samples. Although the sample library is shown in FIG. 1 as being stored in an independent database, it can be understood that the sample library can also be stored in the processing platform. By using evaluation methods in the implementations, the processing platform uses the sample quality of the exemplary samples as a factor in determining the comprehensive similarity between the sample to be evaluated and the exemplary samples. Therefore, impact of the varied sample quality of the exemplary samples on the evaluation results is reduced or avoided.

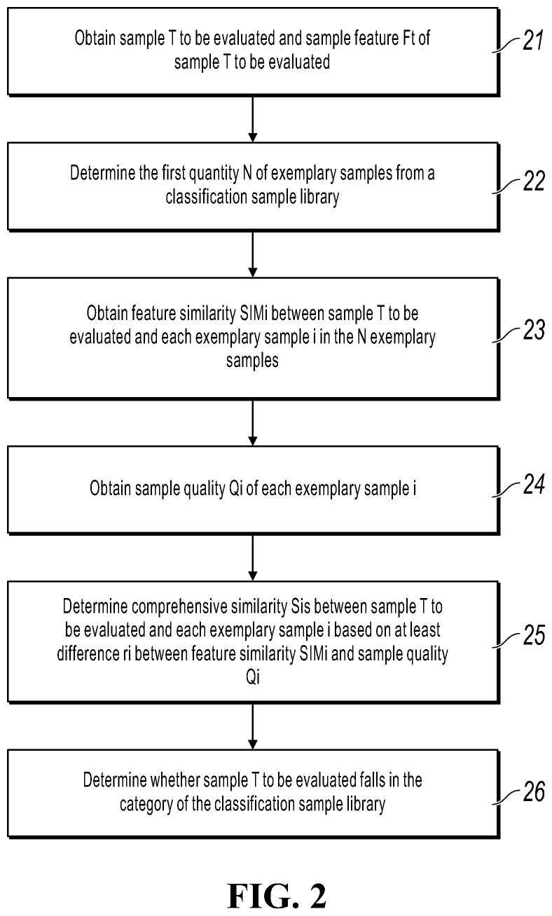

The following describes in detail the method the processing platform used to classify samples to be evaluated. FIG. 2 is a flowchart illustrating a method, according to one implementation. The process can be executed by a processing platform with a computing capability, such as a server, as shown in FIG. 1. As shown in FIG. 2, the method includes the following steps:

Step S21: Obtain sample T to be evaluated and sample feature Ft of sample T to be evaluated.

Step S22: Select the first quantity N of exemplary samples from classification sample library.

Step S23: Obtain feature similarity SIMi between sample T to be evaluated and each exemplary sample i of the first quantity N of exemplary samples, where feature similarity SIMi is determined based on sample feature Ft of sample T to be evaluated and sample feature Fi of each exemplary sample i.

Step S24: Obtain sample quality Qi of each exemplary sample i. Sample quality Qi corresponds to such a similarity threshold that a historical evaluation sample whose feature similarity to the exemplary sample i exceeds the similarity threshold is determined as a specific category in a certain proportion.

Step S25: Determine comprehensive similarity Si between sample T to be evaluated and each exemplary sample i based on at least difference ri between feature similarity SIMi and sample quality Qi.

Step S26: Determine, based on comprehensive similarity Si, whether sample T to be evaluated falls in the category of the classification sample library.

First, in step S21, sample T to be evaluated and sample feature Ft of the sample to be evaluated are obtained. It can be understood that sample T to be evaluated can be various objects to be evaluated and categorized, such as a text, a picture, and code. In one implementation, the processing platform needs to automatically detect, evaluate, or classify various content uploaded onto a network. In this case, obtaining sample T to be evaluated includes capturing the sample to be evaluated from the network. For example, the processing platform needs to filter advertisement images on the network. This allows you to capture samples of images to be evaluated from the network. In another implementation, obtaining sample T to be evaluated includes receiving sample T to be evaluated, that is, the processing platform analyzes and evaluates the received samples to be evaluated. For example, after a mobile phone receives a message, the mobile communications system needs to determine whether it is a junk message. In this case, the message can be sent to the processing platform for SMS classification. The processing platform then evaluates and classifies the received message.

For sample T to be evaluated, sample feature Ft can be extracted. Sample feature Ft is extracted for machine learning and analysis and is used to identify different samples. In the existing technology, many models can be used to extract features of various samples to implement comparison and analysis. For example, for a picture sample, sample features can include the following: quantity of pixels, gray mean value, gray median value, quantity of sub-regions, sub-region area, sub-region gray mean value, etc. For text samples, sample features can include words in text, quantity of words, word frequency, etc. For other types of samples, there are corresponding feature extraction methods. Generally, sample features include a plurality of feature elements, and therefore, sample features can be represented as a feature vector composing a plurality of feature elements.

Ft=(t₁,t₂, . . . tₙ),

where Ti is the feature elements of the sample to be evaluated.

In addition, in step S22, select the first quantity N of exemplary samples from the classification sample library.

It can be understood that the classification sample library is established by collecting samples in advance and is used to classify, compare and identify samples. The library contains a plurality of exemplary samples. For example, a sample library of advertisement pictures contains a large quantity of exemplary advertisement pictures, and a sample library of junk messages contains a plurality of exemplary junk messages.

In one implementation, a quantity of exemplary samples contained in the sample library is small (for example, the quantity of exemplary samples less than a certain threshold (for example, 100)). In this case, all exemplary samples in the sample library may be used for performing subsequent steps S23-S25. That is, the first quantity N in step S22 is the quantity of exemplary samples in the classification sample library.

In another implementation, the quantity of exemplary samples contained in the classification sample library is large. For example, the quantity of exemplary samples is greater than a certain threshold (for example, 200). Alternatively, content of the exemplary samples in the sample library is not concentrated. For example, although all samples stored in the sample library of advertisement pictures are advertisement pictures, content of these pictures differs because these picture may contain either people or things or scenery. In this case, the exemplary samples in the sample library can be filtered to determine a quantity N of more targeted exemplary samples for further processing.

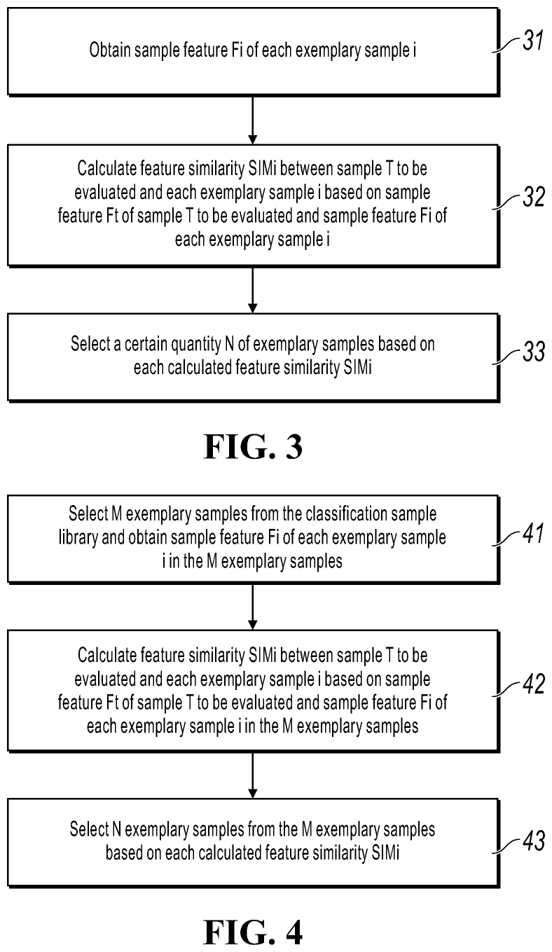

Many ways can be used to determine a certain quantity N of exemplary samples from the classification sample library. FIG. 3 is a flowchart illustrating selection of a quantity of exemplary samples based on one implementation. As shown in FIG. 3, first in step S31, sample feature Fi of each exemplary sample i in a classification sample library are obtained. It can be understood that, in correspondence with the sample to be evaluated, sample feature Fi of each exemplary sample i may similarly be represented by a feature vector.

Fᵢ=(fᵢ₁,fᵢ₂, . . . fᵢₙ)

In step S32, feature similarity SIMi between sample T to be evaluated and each exemplary sample i is calculated based on sample feature Ft of sample T to be evaluated and sample feature Fi of each exemplary sample i.

In one implementation, the distance di between sample T to be evaluated and the exemplary sample i is first calculated, and the distance di is normalized to obtain feature similarity SIMi. It can be understood that because both sample T to be evaluated and the exemplary sample i can be represented in the form of a feature vector, various algorithms can be used to calculate the distance between the two vectors as the distance di. For example, the Euclidean distance between feature vector Ft of sample T to be evaluated and feature vector Fi of the exemplary sample i may be calculated as the distance di using a conventional mathematical method. Alternatively, the Mahalanobis distance or the Hamming distance, etc. between Ft and Fi may be calculated as the distance di between sample T to be evaluated and the exemplary sample i. Then, the distance can be normalized to obtain feature similarity SIMi. In one example, the distance is normalized by using the following equation:

SIMi=1−di/100.

Therefore, the value of SIMi ranges between 0 and 1. It can be understood that other normalization methods can also be used.

In one implementation, feature similarity SIMi between sample T to be evaluated and the exemplary sample i is determined based on cosine similarity between feature vector Ft and feature vector Fi. In this method, the cosine value of the angle between feature vector Ft and feature vector Fi is used to directly determine feature similarity SIMi between 0 and 1. A person skilled in the field may also use other algorithms to determine the feature similarity based on the respective feature vectors of sample T to be evaluated and the sample feature i.

Therefore, in step S32, feature similarity SIMi between sample T to be evaluated and each exemplary sample i in the sample library is calculated. Next, in step S33, a certain quantity N of exemplary samples are selected from the classification sample library based on each of calculated feature similarity SIMi.

In one implementation, feature similarity SIMi between sample T to be evaluated and each exemplary sample i is first sorted, and the N exemplary samples are selected based on the sorting results.

In one example, the N exemplary samples with the highest feature similarity to sample T to be evaluated are selected. For example, N can be 10 or 20. Of course, exemplary samples whose feature similarities are sorted in a predetermined range, such as between the 5th and the 15th, are selected. The method for selecting exemplary samples can be set as needed.

In another example, exceptional values of the feature similarities that deviate from the predetermined range are first removed, and the N exemplary samples with the highest feature similarities are selected from the sorting result after the exceptional values are removed.

In still another implementation, the certain quantity N is not predetermined. Correspondingly, an exemplary sample with feature similarity in a predetermined range can be selected as a selected exemplary sample. For example, you can predetermine a threshold and select exemplary samples with feature similarity SIMi greater than the threshold.

As such, a certain quantity (N) of exemplary samples are selected from the classification sample library, and the selected exemplary samples have a higher feature similarity to the sample to be evaluated, that is, features of the selected exemplary samples are more similar to features of the sample to be evaluated. Therefore, they are more targeted and more favorable for the accuracy of subsequent processing results.

The process of selecting exemplary samples can also be implemented in other ways. FIG. 4 is a flowchart diagram illustrating selection of a certain quantity (the first number N) of exemplary samples, according to another implementation. As shown in FIG. 4, first in step S41, M (the second quantity) exemplary samples are selected from a classification sample library to obtain sample feature Fi of each exemplary sample i of the M exemplary samples. It can be understood that the second quantity M of exemplary samples are initially selected exemplary samples, and the quantity M is greater than the previous first quantity N. In one implementation, the next step is performed by randomly selecting M exemplary samples from the classification sample library. Alternatively, the most recently used M exemplary samples are selected from the classification sample library to perform the next step. The second quantity M can also be determined based on a predetermined ratio, for example, 50% of the total quantity of all exemplary samples in the classification sample library.

Next, in step S42, feature similarity SIMi between sample T to be evaluated and each exemplary sample i is calculated based on sample feature Ft of sample T to be evaluated and sample feature Fi of each exemplary sample i of the selected M exemplary samples. For the method for calculating feature similarity SIMi in the present step, references can be made to the description of step S32 in FIG. 3. Details are omitted here for simplicity.

Then in step S43, the first quantity N of exemplary samples is further selected from the M exemplary samples based on calculated feature similarities SIMis. For the method for selecting the N exemplary samples from more exemplary samples based on feature similarity SIMi in the present step, references can be made to descriptions of step S33 in FIG. 3. Details are omitted here for simplicity.

As can be seen from the comparison between the implementation in FIG. 4 and the implementation in FIG. 3, the implementation in FIG. 4 differs from the implementation in FIG. 3 in that the M exemplary samples are initially selected from the classification sample library to calculate the feature similarity between the sample to be evaluated and the M exemplary samples, and then the N exemplary samples are further selected from the M exemplary samples based on the feature similarity. This is particularly applicable when the quantity of exemplary samples in the classification sample library is very large. In this case, the computational cost of calculating the feature similarity between each exemplary sample in the classification sample library and the sample to be evaluated (step S32) is still high and the implementation in FIG. 4 can be adopted.

In practice, the N exemplary samples finally selected are typically in the level of ten, such as 10, 20, and 50. Therefore, the implementation in FIG. 3 can be adopted if the quantity of the exemplary samples in the classification sample library is in the level of thousand. If the quantity of exemplary samples in the classification sample library is very large, for example, there are tens of thousands or even hundreds of thousands of exemplary samples, to speed up processing, the method in the implementation in FIG. 4 can be adopted. First, a portion of M exemplary samples are selected from the classification sample library. For example, the quantity of the M exemplary samples may be several thousand or several hundred. Then tens of exemplary samples are further selected based on the feature similarity for subsequent processing.

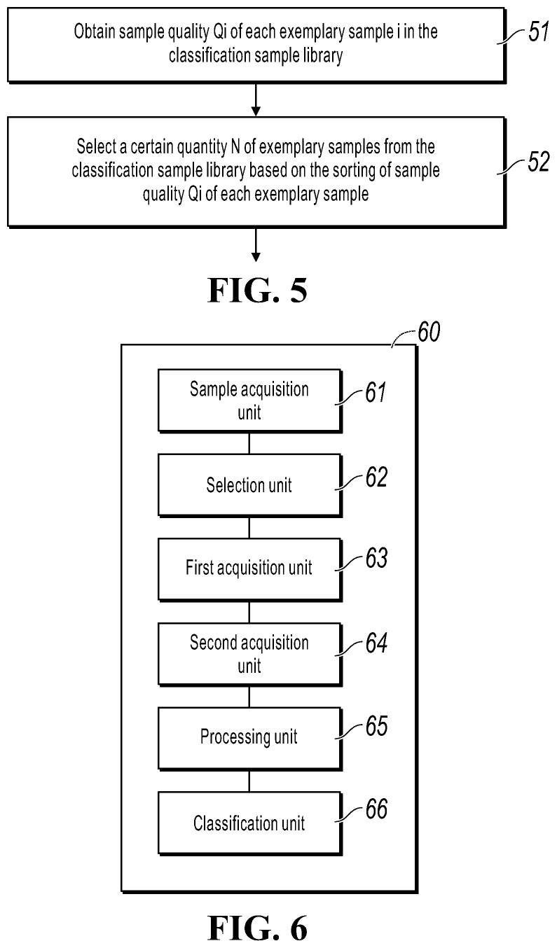

FIG. 5 is a flowchart illustrating selection of a quantity of exemplary samples, according to still another implementation. As shown in FIG. 5, in step S51, sample quality Qi of each exemplary sample i in a classification sample library is obtained.

Sample quality Qi is used to measure the generalization ability of an exemplary sample. The exemplary sample corresponds to such a similarity threshold that a historical evaluation sample whose feature similarity to the exemplary sample i exceeds the similarity threshold is determined in a proportion to fall in the same category as the classification sample library. In one example, a historical evaluation sample whose feature similarity to the exemplary sample i exceeds the similarity threshold is considered as falling in the same category as the classification sample library. Therefore, when the feature similarity between the sample to be evaluated and the exemplary sample exceeds Qi, the sample to be evaluated and the exemplary sample probably fall in the same category. For example, for an exemplary sample in a junk SMS sample library, if its sample quality is 0.6, this means if feature similarity of a sample to be evaluated exceeds 0.6, there is a great probability that the sample to be evaluated is also a junk SMS. For another example, for an exemplary sample in an advertisement picture sample library, if its sample quality is 0.8, this means if feature similarity of a sample to be evaluated exceeds 0.8, there is a great probability that the sample to be evaluated is also an advertisement picture. Generally, the sample with low sample quality Q has a strong generalization ability.

Sample quality Qi can be determined in several ways. In one implementation, the sample quality of each exemplary sample is determined through manual calibration, and exemplary samples are stored in the classification sample library. In another implementation, sample quality Qi is determined based on historical data of sample evaluation classification. Specifically, the sample quality of a certain exemplary sample is determined by obtaining feature similarities between a plurality of historical evaluation samples from previous historical records and the exemplary sample and the final evaluation results of the plurality of historical evaluation samples. More specifically, the lowest value among feature similarities between the exemplary sample and the historical records that are finally identified as falling in the same category can be determined as the sample quality of the exemplary sample. For example, for exemplary sample k, five historical evaluation samples were compared with it in historical records. Assume that the results of the comparison show that the feature similarities of these five historical evaluation samples to sample k are SIM1=0.8, SIM2=0.6, SIM3=0.4, SIM4=0.65, SIM5=0.7 respectively. Finally, the historical evaluation samples whose feature similarities are 0.6 and 0.4 are not considered to be in the same category as sample k, and other historical evaluation samples are considered to be in the same category. In this case, sample quality Q of sample k can be considered to be 0.65, that is, the lowest value among the feature similarities between sample k and the three historical evaluation samples that fall in the same category.

In one implementation, in step S51, sample quality Qi of each exemplary sample i in a classification sample library is calculated by the historical records. In another implementation, the sample quality has been pre-calculated and is stored in the sample library. In step S51, sample quality Qi of each exemplary sample i is read.

Next, in step S52, a certain quantity N of exemplary samples are selected from the classification sample library based sorting of the sample quality Qi of each exemplary sample i described above. In one implementation, N exemplary samples with the lowest values of Qi are selected from the classification sample library. In another implementation, a value of N is not specified in advance. In this case, exemplary samples whose values of sample quality Qi are below a certain threshold can be selected. In this way, N exemplary samples with a strong generalization ability are selected from the classification sample library for further processing.

In addition to the methods shown in FIG. 3, FIG. 4, and FIG. 5, a person skilled in the field can use a similar method to select the first quantity N of exemplary samples from the classification sample library after reading this specification. By performing the previous process, step S22 in FIG. 2 is performed.

Referring back to FIG. 2, on the basis of selecting the N exemplary samples, in step S23, feature similarity SIMi between sample T to be evaluated and each exemplary sample I of the N exemplary samples are obtained, where feature similarity SIMi is determined based on sample feature Ft of sample T to be evaluated and sample feature Fi of each exemplary sample i.

It can be understood that if the N exemplary samples are selected in the methods shown in FIG. 3 or FIG. 4, feature similarities SIMis between sample T to be evaluated and all exemplary samples/the M exemplary samples have been calculated during the selection process. Correspondingly, in step S23, only the feature similarities between sample T to be evaluated and the N selected exemplary samples needs to be read from the calculation result.

If other methods are used to select the N exemplary samples, then in step S23, feature similarity SIMi between sample T to be evaluated and each exemplary sample i is calculated based on sample feature Ft of sample T to be evaluated and sample feature Fi of each exemplary sample i in the N selected exemplary samples. For the calculation method, references can be made to the description of step S32 in FIG. 3. Details are omitted here for simplicity.

In addition, in step S24, sample quality Qi of each of the N exemplary samples selected is obtained.

It can be understood that if the N exemplary samples are selected in the method shown in FIG. 5, the sample quality of all exemplary samples has been obtained during the selection process. Correspondingly, in step S24, only the sample quality of the N selected exemplary samples needs to be read from all results.

If the N exemplary samples are selected in other methods, in step S24, obtain sample quality of the N exemplary samples. For the method for obtaining the sample quality, references can be made to the description of step S51 in FIG. 5. Details are omitted here for simplicity.

On the basis of obtaining feature similarity SIMi between each exemplary sample i and the sample to be evaluated, and sample quality Qi of each exemplary sample, in step S25, comprehensive similarities Sis between sample to be evaluated and each exemplary sample i are obtained at least based on difference ri between feature similarity SIMi and sample quality Qi.

In one implementation, comprehensive similarity Si is determined to be Si=a+b*ri*c, where a and b are constants, a+b=1, and c is a coefficient associated with sample quality Qi.

For example, in one example, Si=0.8+0.2*ri/2Qi;

In another example, Si=0.7+0.3*ri/Qi.

In one implementation, parameter c is set to be different values for different values of ri. For example, in the case of ri>=0, c=1/(1−Qi) and in the case of ri<0, c=1/Qi.

In an example, the calculation of Si is as follows:

$${S}_{i} = \{ \begin{matrix}0.9 + 0.1 \times {r}_{i} / ( 1 - {Q}_{i} ) & {r}_{i} \geq 0 \\ 0.9 + 0.1 \times {r}_{i} / {Q}_{i} & {r}_{i} < 0\end{matrix} \qquad ( 1 )$$

In the previous equation, in the case of ri>=0, c=1/(1−Qi). Therefore, rᵢ/(1−Qᵢ) is not greater than 1, and Si is not greater than 1. In addition, the difference ri between the feature similarity SIMi and the sample quality Qi can be better measured. If a value of Qi is relatively large or even closer to 1, a margin (1−Qi) of difference ri must be very small. In this case, Si should be calculated by considering the ratio of difference ri to its possible margin. In the case of ri<0, c can be directly set to be 1/Qi, and Si can be calculated by considering the ratio of difference ri to Qi.

In the process of calculating the comprehensive similarity, because the sample quality and the difference between the feature similarity and the sample quality are comprehensively considered, the resulting comprehensive similarity can more objectively reflect the probability that the sample to be evaluated and the exemplary sample fall in the same category, and is less affected by the sample quality of the exemplary sample. For example, assume there are two exemplary samples A and B, and sample quality is QA=0.4 and QB=0.8 respectively. Assume that feature similarity between sample T to be evaluated and sample A and feature similarity between sample T to be evaluated and sample B are both 0.7. In such a situation, if the feature similarity is the only factor, it is generally considered that the sample to be evaluated is either similar to or not similar to both exemplary samples because the feature similarity between sample T to be evaluated and sample A and the feature similarity between sample T to be evaluated and sample B are the same. If the method in the previous implementation is used, for example, algorithm of equation 1 is used, a comprehensive similarity SA=0.95 between the sample to be evaluated and sample A, and a comprehensive similarity SB=0.8875 between the sample to be evaluated and sample B are obtained. The comprehensive similarity shows that the degree of similarity between the sample to be evaluated and sample A is different from the degree of similarity between the sample to be evaluated and sample B. Exemplary sample A has a sample quality valued at only 0.4, and feature similarity between the sample to be evaluated and sample A is much greater than the threshold for falling in the same category, so comprehensive similarity of sample A is significantly higher. Therefore, the resulting comprehensive similarity can more objectively reflect the probability that the sample to be evaluated and the exemplary sample fall in the same category.

As such, in step S25, comprehensive similarities between sample T to be evaluated and the N exemplary samples are respectively calculated. Further, in step S26, it can be determined whether sample T to be evaluated falls in the category of the classification sample library based on the comprehensive similarity Si.

In one implementation, obtained N comprehensive similarities Sis are sorted to determine the highest comprehensive similarity. The highest comprehensive similarity is compared with a predetermined threshold, and if it is greater than the threshold, sample T to be evaluated is considered to fall in the same category as the classification sample library.

In one implementation, total similarity score of the sample to be evaluated is determined based on the N comprehensive similarities between sample T to be evaluated and the N exemplary samples, and whether sample T to be evaluated falls in the category of the classification sample library is determined based on the total similarity score. The total similarity score is used to measure the degree of similarity between the sample to be evaluated and the entire exemplary sample set, or the degree of similarity between the sample to be evaluated and the entire classification sample library, and the probability of falling in the same category.

In one implementation, an average value of comprehensive similarity SIMi between sample T to be evaluated and each exemplary sample i is calculated, and the average value is determined as the previous total similarity score.

In another implementation, if at least one of N differences ris corresponding to the N exemplary samples is greater than or equal to 0, the total similarity score is determined as the maximum value among the comprehensive similarities between sample T to be evaluated and the N exemplary samples. Otherwise, the total similarity score is determined as the minimum value among the comprehensive similarities between sample T to be evaluated and the N exemplary samples.

Because sample quality difference of each exemplary sample is taken into account in determining the total comprehensive score, the sample to be evaluated can be determined by setting an appropriate total score threshold in advance. Correspondingly, in step S26, the total similarity score is compared with the predetermined total score threshold, and if the total similarity score of the sample to be evaluated is greater than the predetermined total score threshold, the sample to be evaluated can be determined as falling in the category of the classification sample library. For example, if the sample to be evaluated is a received message, as long as its total similarity score to a junk SMS sample library is greater than the predetermined threshold, the message is also a junk message.

According to the method in the previous implementation, the feature similarity between the sample to be evaluated and the exemplary sample and the sample quality of the sample to be evaluated are comprehensively considered to determine the comprehensive similarity of the sample to be evaluated and the exemplary sample. Therefore, the adverse impact of varied sample quality on the evaluation results is reduced or avoided.

According to an implementation of another aspect, this specification also provides an apparatus for classifying samples to be evaluated. FIG. 6 is a schematic block diagram illustrating a classification apparatus, according to one implementation. As shown in FIG. 6, classification apparatus 60 includes: sample acquisition unit 61, configured to obtain a sample T to be evaluated and sample feature Ft of sample T to be evaluated; selection unit 62, configured to select the first quantity N of exemplary samples from a classification sample library; first acquisition unit 63, configured to obtain feature similarity SIMi between sample T to be evaluated and each exemplary sample i of the N exemplary samples, where the feature similarity SIMi is determined based on sample feature Ft of sample T to be evaluated and sample feature Fi of each exemplary sample i; second acquisition unit 64, configured to obtain sample quality Qi of each exemplary sample i, where sample quality Qi corresponds to such a similarity threshold that historical evaluation samples whose feature similarities to the exemplary sample i exceed the similarity threshold are determined in a certain proportion as falling in the category of the classification sample library; processing unit 65, configured to determine comprehensive similarities Sis between sample T to be evaluated and each exemplary sample i based on at least difference ri between feature similarity SIMi and sample quality Qi; and classification unit 66, configured to determine, based on comprehensive similarity Si, whether sample T to be evaluated falls in the category of the classification sample library.

In one implementation, selection unit 62 includes a calculation subunit (not shown), configured to calculate, based on sample feature Ft of sample T to be evaluated and the sample features of the second quantity M of exemplary samples in the classification sample library, feature similarities between each exemplary sample of the second quantity M of exemplary samples and sample T to be evaluated, where the second quantity M is greater than the first quantity N; and a selection subunit, configured to select the first quantity N of exemplary samples from the second quantity M of exemplary samples based on feature similarities between each of the second quantity M of exemplary samples and the sample to be evaluated.

In one implementation, the selection subunit is configured to select, from the second quantity M of exemplary samples, the first quantity N of exemplary samples with the highest feature similarities to sample T to be evaluated.

According to one implementation, selection unit 62 is configured to select the first quantity N of exemplary samples from the classification sample library based on sorting of the sample quality of each exemplary sample in the classification sample library.

In one implementation, feature similarity SIMi is determined by normalizing the distance between sample feature Ft of sample T to be evaluated and sample feature Fi of each exemplary sample i.

According to one implementation, processing unit 65 is configured to determine comprehensive similarity Si as Si=a+b*ri*c, where a+b=1, and c is a coefficient associated with sample quality Qi.

In one implementation, in the case of ri>=0, c=1/(1−Qi) and in the case of ri<0, c=1/Qi.

According to one implementation, classification unit 66 is configured to determine, based on comprehensive similarities Sis between sample T to be evaluated and each exemplary sample i, total similarity scores of the sample to be evaluated and to determine, based on the total similarity score, whether sample T to be evaluated falls in the category of the classification sample library.

In one implementation, classification unit 66 is further configured to: if at least one ri>=0, determine the total similarity score as the maximum value among comprehensive similarities Sis between sample T to be evaluated and each exemplary sample i; or otherwise, determine the total similarity score as the minimum value among comprehensive similarities Sis between sample T to be evaluated and each exemplary sample i.

In one implementation, classification unit 66 is configured to determine the total similarity score as the average score of the comprehensive similarities Sis between sample T to be evaluated and each exemplary sample i.

According to the apparatus in the previous implementation, the feature similarity of the sample to be evaluated and the sample quality of the exemplary sample can be comprehensively considered in determining the comprehensive similarity between the sample to be evaluated and the exemplary sample. Therefore, the adverse impact of varied sample quality on the evaluation results is reduced or avoided.

According to another implementation, a computer readable storage medium is also provided, where the computer readable storage medium stores a computer program, and when the computer program is executed in a computer, the computer is enabled to perform the methods described with reference to FIG. 2 to FIG. 5.

According to still another implementation, a computing device is further provided, including a memory and a processor, where the memory stores executable code, and when the processor executes the executable code, the methods described with reference to FIG. 2 to FIG. 5 are implemented.

A person skilled in the field should be aware that, in one or more of the previous examples, the functions described in the present invention can be implemented in hardware, software, firmware, or any combination of them. When these functions are implemented by software, they can be stored in a computer readable medium or transmitted as one or more instructions or code lines on the computer readable medium.

The specific implementations further describe the object, technical solutions and beneficial effects of the present invention. It should be understood that the previous descriptions are merely specific implementations of the present invention and are not intended to limit the protection scope of the present invention. Any modification, equivalent replacement and improvement made on the basis of the technical solution of the present invention shall fall within the protection scope of the present invention.

What is claimed is:

1. A computer-implemented method for classifying samples, comprising:
obtaining a candidate sample (T) and respective features (Ft) of the candidate sample (T);
selecting N samples from a classification sample library, where N is a predetermined positive integer;
determining a feature similarity (SIMi) between the candidate sample (T) and each of the N samples (i), wherein the feature similarity (SIMi) is determined based on the respective features (Ft) of the candidate sample (T) and respective features (Fi) of each sample (i);
obtaining a sample quality (Qi), wherein the sample quality (Qi) is of each sample (i);
determining, as comprehensive similarity measures (Si), a comprehensive similarity measure (Si) between the candidate sample (T) and each sample (i) at least based on a difference (ri) between the feature similarity (SIMi) and the sample quality (Qi); and
determining, based on the comprehensive similarity measures (Si), whether the candidate sample (T) belongs to a classification within the classification sample library.

2. The computer-implemented method according to claim 1, wherein the selecting the N samples from the classification sample library comprises:
determining a feature similarity between the candidate sample (T) and each of M samples based on the respective features (Ft) of the candidate sample (T) and respective features of each of the M samples in the classification sample library, where M is a predetermined positive integer and is greater than N; and
selecting the N samples from the M samples based on the feature similarity between the candidate sample (T) and each of the M samples.

3. The computer-implemented method according to claim 2, wherein selecting the N samples from the M samples based on the feature similarity between the candidate sample (T) and each of the M samples, comprises:
selecting N samples from the M samples, wherein, in relation to the candidate sample (T), the feature similarity (SIMi) of the N samples are highest in value.

4. The computer-implemented method according to claim 1, wherein selecting the N samples from the classification sample library comprises:
sorting samples in the classification sample library according to respective sample qualities of the samples.

5. The computer-implemented method according to claim 1, wherein the feature similarity (SIMi) is determined by normalizing a distance between the respective features (Ft) of the candidate sample (T) and the respective features (Fi) of each sample (i).

6. The computer-implemented method according to claim 1, wherein determining a comprehensive similarity measure (Si) between the candidate sample (T) and each sample (i) comprises:
determining the comprehensive similarity measure (Si) as Si=a+b*ri*c, wherein a+b=1 and c is a coefficient associated with the sample quality (Qi).

7. The computer-implemented method according to claim 6, wherein:
if ri>=0: c=1/(1−Qi); and
if ri<0: c=1/Qi.

8. The computer-implemented method according to claim 1, wherein determining, based on the comprehensive similarity measures (Si), whether the candidate sample (T) belongs to a classification within the classification sample library, comprises:
determining, based on the comprehensive similarity measures (Si), a combined similarity score of the candidate sample; and
determining, based on the combined similarity score, whether the candidate sample (T) belongs to the classification within the classification sample library.

9. The computer-implemented method according to claim 8, wherein determining, based on the comprehensive similarity measures (Si), a combined similarity score of the candidate sample, comprises:
if at least one ri is greater than or equal to 0, determining the combined similarity score using a maximum value among the comprehensive similarity measures (Si); or
if no ri is greater than or equal to 0, determining the combined similarity score using a minimum value among the comprehensive similarity measures (Si).

10. The computer-implemented method according to claim 8, wherein determining the combined similarity score of the candidate sample comprises:
determining the combined similarity score using an average value of the comprehensive similarity measures (Si) between the candidate sample (T) and the N samples (i).

11. A non-transitory, computer-readable medium storing one or more instructions executable by a computer system to perform one or more operations for classifying samples, comprising:
obtaining a candidate sample (T) and respective features (Ft) of the candidate sample (T);
selecting N samples from a classification sample library, where N is a predetermined positive integer;
determining a feature similarity (SIMi) between the candidate sample (T) and each of the N samples (i), wherein the feature similarity (SIMi) is determined based on the respective features (Ft) of the candidate sample (T) and respective features (Fi) of each sample (i);
obtaining a sample quality (Qi), wherein the sample quality (Qi) is of each sample (i);
determining, as comprehensive similarity measures (Si), a comprehensive similarity measure (Si) between the candidate sample (T) and each sample (i) at least based on a difference (ri) between the feature similarity (SIMi) and the sample quality (Qi); and
determining, based on the comprehensive similarity measures (Si), whether the candidate sample (T) belongs to a classification within the classification sample library.

12. The non-transitory, computer-readable medium according to claim 11, wherein the selecting the N samples from the classification sample library comprises:
determining a feature similarity between the candidate sample (T) and each of M samples based on the respective features (Ft) of the candidate sample (T) and respective features of each of the M samples in the classification sample library, where M is a predetermined positive integer and is greater than N; and
selecting the N samples from the M samples based on the feature similarity between the candidate sample (T) and each of the M samples.

13. The non-transitory, computer-readable medium according to claim 12, wherein selecting the N samples from the M samples, comprises:
selecting N samples from the M samples, wherein, in relation to the candidate sample (T), the feature similarity (SIMi) of the N samples are highest in value.

14. The non-transitory, computer-readable medium according to claim 11, wherein selecting the N samples from the classification sample library comprises:
sorting samples in the classification sample library according to respective sample qualities of the samples.

15. The non-transitory, computer-readable medium according to claim 11, wherein the feature similarity (SIMi) is determined by normalizing a distance between the respective features (Ft) of the candidate sample (T) and the respective features (Fi) of each sample (i).

16. The non-transitory, computer-readable medium according to claim 11, wherein determining a comprehensive similarity measure (Si) between the candidate sample (T) and each sample (i) comprises:
determining the comprehensive similarity measure (Si) as Si=a+b*ri*c, wherein a+b=1 and c is a coefficient associated with the sample quality (Qi).

17. The non-transitory, computer-readable medium according to claim 16, wherein:
if ri>=0: c=1/(1−Qi); and
if ri<0: c=1/Qi.

18. The non-transitory, computer-readable medium according to claim 11, wherein determining, based on the comprehensive similarity measures (Si), whether the candidate sample (T) belongs to a classification within the classification sample library, comprises:
determining, based on the comprehensive similarity measures (Si), a combined similarity score of the candidate sample; and
determining, based on the combined similarity score, whether the candidate sample (T) belongs to the classification within the classification sample library.

19. The non-transitory, computer-readable medium according to claim 18, wherein determining a combined similarity score of the candidate sample, comprises:
if at least one ri is greater than or equal to 0, determining the combined similarity score using a maximum value among the comprehensive similarity measures (Si); or
if no ri is greater than or equal to 0, determining the combined similarity score using a minimum value among the comprehensive similarity measures (Si).

20. The non-transitory, computer-readable medium according to claim 18, wherein determining the combined similarity score of the candidate sample comprises:
determining the combined similarity score using an average value of the comprehensive similarity measures (Si) between the candidate sample (T) and the N samples (i).

21. A computer-implemented system for classifying samples, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining a candidate sample (T) and respective features (Ft) of the candidate sample (T);
selecting N samples from a classification sample library, where N is a predetermined positive integer;
determining a feature similarity (SIMi) between the candidate sample (T) and each of the N samples (i), wherein the feature similarity (SIMi) is determined based on the respective features (Ft) of the candidate sample (T) and respective features (Fi) of each sample (i);
obtaining a sample quality (Qi), wherein the sample quality (Qi) is of each sample (i);
determining, as comprehensive similarity measures (Si), a comprehensive similarity measure (Si) between the candidate sample (T) and each sample (i) at least based on a difference (ri) between the feature similarity (SIMi) and the sample quality (Qi); and
determining, based on the comprehensive similarity measures (Si), whether the candidate sample (T) belongs to a classification within the classification sample library.

22. The computer-implemented system according to claim 21, wherein the selecting the N samples from the classification sample library comprises:
determining a feature similarity between the candidate sample (T) and each of M samples based on the respective features (Ft) of the candidate sample (T) and respective features of each of the M samples in the classification sample library, where M is a predetermined positive integer and is greater than N; and
selecting the N samples from the M samples based on the feature similarity between the candidate sample (T) and each of the M samples.

23. The computer-implemented system according to claim 22, wherein the selecting the N samples from the M samples comprises:
selecting, from the M samples, the N samples with highest feature similarities with the candidate sample (T).

24. The computer-implemented system according to claim 21, wherein selecting the N samples from the classification sample library comprises:
sorting samples in the classification sample library according to respective sample qualities of the samples.

25. The computer-implemented system according to claim 21, wherein the feature similarity (SIMi) is determined by normalizing a distance between the respective features (Ft) of the candidate sample (T) and the respective features (Fi) of each sample (i).

26. The computer-implemented system according to claim 21, wherein determining a comprehensive similarity measure (Si) between the candidate sample (T) and each sample (i) comprises:
determining the comprehensive similarity measure (Si) as Si=a+b*ri*c, wherein a+b=1 and c is a coefficient associated with the sample quality (Qi).

27. The computer-implemented system according to claim 26, wherein:
if ri>=0: c=1/(1−Qi); and
if ri<0: c=1/Qi.

28. The computer-implemented system according to claim 21, wherein determining, based on the comprehensive similarity measures (Si), whether the candidate sample (T) belongs to a classification within the classification sample library, comprises:
determining, based on the comprehensive similarity measures (Si), a combined similarity score of the candidate sample; and
determining, based on the combined similarity score, whether the candidate sample (T) belongs to the classification within the classification sample library.

29. The computer-implemented system according to claim 28, wherein determining a combined similarity score of the candidate sample, comprises:
if at least one ri is greater than or equal to 0, determining the combined similarity score using a maximum value among the comprehensive similarity measures (Si); or
if no ri is greater than or equal to 0, determining the combined similarity score using a minimum value among the comprehensive similarity measures (Si).

30. The computer-implemented system according to claim 28, wherein determining the combined similarity score of the candidate sample comprises:
determining the combined similarity score using an average value of the comprehensive similarity measures (Si) between the candidate sample (T) and the N samples (i).
